(19) United States
(12) Patent Application Publication
(10) Pub. No.: US 2005/0099639 A1
(43) Pub. Date: May 12, 2005

(54) Methods for providing periodic status updates from a printer and a printer capable of providing periodic status updates

(75) Inventors: Stephen R. Payne, Cortland, NY (US); Richard S. Quaif, Dryden, NY (US)

Correspondence Address: Lipsitz & McAllister, LLC, 755 MAIN STREET, MONROE, CT, 06468, US

(73) Assignee: TransAct Technologies Incorporated, Wallingford, CT (US)

(21) Appl. No.: 10/802,352

(22) Filed: Mar. 16, 2004

Related U.S. Application Data
(60) Provisional application No. 60/519,521, filed on Nov. 12, 2003.

(51) Int. Cl. G06F 15/00

(52) U.S. Cl. 358/1.1; 358/1.15

(57) ABSTRACT

The present invention relates to methods for providing periodic status updates from a printer to a host system, and a printer capable of providing such status updates. A printer in accordance with the present invention includes means for generating printer status information and means for automatically sending the printer status information to the host system at periodic time intervals, without the need for a status request from the host system or a status change at the printer. The time interval and/or the status information may be configured via the host system.

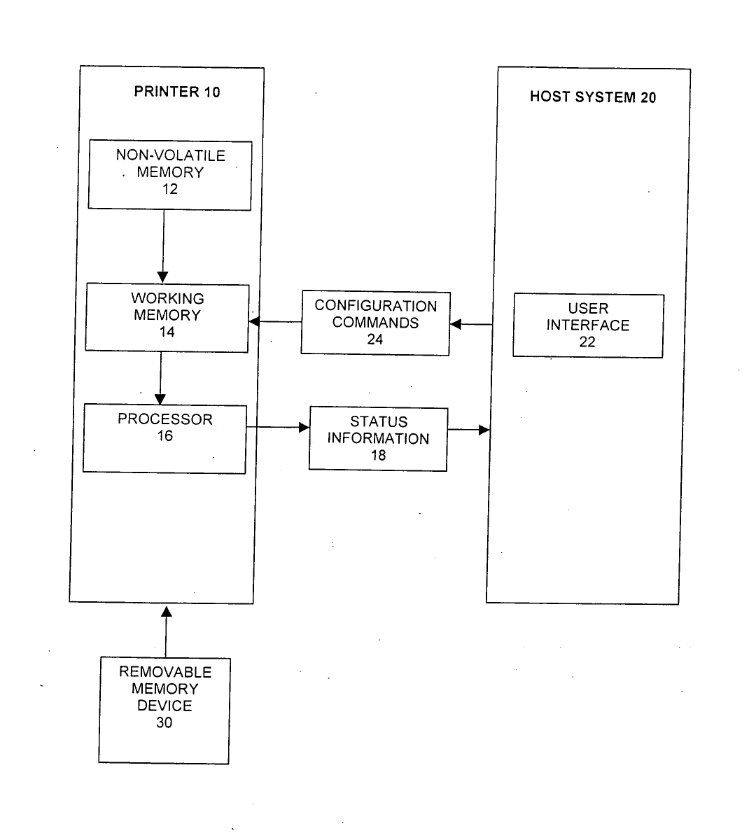

This application claims the benefit of U.S. provisional patent application No. 60/519,521 filed on Nov. 12, 2003, entitled “Smart Printer Including Configurable Ticket Template, Status Updating, Color Conversion, Print Progress Detection, Print Completion Detection, and Paper Low Sensing Features,” which is incorporated herein and made a part hereof by reference.

### BACKGROUND OF THE INVENTION

The present invention relates generally to the field of printing. More specifically, the present invention relates to methods for providing periodic status updates from a printer to a host system, and a printer capable of providing such status updates.

In the prior art, status updating from a printer to a host system is typically accomplished in one of two ways. The first method is for the host system to send a “status request” command to the printer. The printer then responds to the status request command by communicating status information back to the host system. With this method, when the host system wants status information from the printer, it must request the status information from the printer. The printer will then respond with the requested status information. This method has the disadvantage that there is a delay in getting the response from the printer. These delays can accumulate and result in sluggish printer and/or host system performance.

The second method is for the printer to determine when its status has changed and then communicate the status to the host system. This method has the advantage that the host system does not have to ask for printer status. However, a disadvantage of this method is that it may hide the fact that the printer has become non-responsive or non-functional due to some sort of failure. Such a failure could be due to an ESD (Electro Static Discharge) event, an electronic failure, a communication cable breakage, or the like.

It would therefore be advantageous to provide status updates from the printer to the host system automatically, without the need for a status request from the host system. It would be further advantageous if such status updates from the printer to the host system are sent periodically, whether or not the printer status has changed.

The methods and apparatus of the present invention provide the foregoing and other advantages.

### SUMMARY OF THE INVENTION

The present invention relates to methods for providing periodic status from a printer to a host system, and a printer capable of providing such status updates.

In an example embodiment of the present invention, a printer capable of providing periodic status updates to a host system is provided. The printer includes means for generating printer status information and means for automatically sending the printer status information to the host system at periodic time intervals. For example, the printer status information may be generated by a processor at the printer and communicated to the host system under control of the processor.

The periodic time intervals may each comprise a constant time interval of between 5 seconds and 10 milliseconds. The periodic time interval may be configurable.

The status information may comprise at least one of paper status, ink status, paper low, paper out, paper jam, ticket in path, top of form, barcode complete, validation field complete, field printed, percentage of printing completed, and the like.

At least one of the time interval and the status information may be configured via the host system. For example, the time interval and status information may be configured by entering commands at a user interface associated with the host system and sending such commands to the printer.

Non-volatile memory may be provided for storing at least one of the time interval and the status information at the printer.

In an alternative example embodiment, at least one of the time interval or the status information may be provided from a removable memory device insertable into the printer. The removable memory device may comprise one of a compact flash card, a smart card, a smart media card, a USB flash drive, a memory stick, a plug in serial EEPROM, or the like.

The means for generating the printer status information may detect an activity level at the printer, and (1) decreases the periodic time interval when the activity level increases; or (2) increases the periodic time interval when the activity level decreases.

The host system may comprise one of a cash register, a point of sale terminal, a slot machine, a gaming terminal, a lottery ticket machine, a transportation ticket vending machine, an entertainment ticket vending machine, or the like.

The present invention also includes corresponding methods for providing periodic status updates from a printer to a host system.

### BRIEF DESCRIPTION OF THE DRAWINGS

The present invention will hereinafter be described in conjunction with the appended drawing figures, wherein like numerals denote like elements, and:

The FIGURE shows a block diagram of an example embodiment of the present invention.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an example embodiment of the invention. It should be understood that various changes may be made in the function and arrangement of elements without departing from the spirit and scope of the invention as set forth in the appended claims.

In an example embodiment of the present invention as shown in the FIGURE, a printer 10 capable of providing periodic status updates to a host system 20 is provided. The printer 10 includes means for generating printer status information and means for automatically sending the printer status information 18 to the host system 20 at periodic time intervals. For example, the printer status information may be obtained by a processor 16 from memory 14 at the printer 10 and communicated to the host system 20 under control of the processor 16.

The periodic time intervals may each comprise a constant time interval of between 5 seconds and 10 milliseconds. The periodic time interval may be configurable. For example, the periodic time interval between status updates may be increased during an idle period of the printer and decreased when the printer becomes active. Further, the status updates may cease when the printer is idle for a predetermined period of time and resume when a print command is sent to the printer. The predetermined period of time the printer is idle before the status updates cease may be configurable.

The status information 18 may comprise at least one of paper status, ink status, paper low, paper out, paper jam, ticket in path, top of form, barcode complete, validation field complete, field printed, percentage of printing completed, and the like.

At least one of the time interval and the status information may be configured via the host system 20. For example, the time interval and status information may be configured by entering commands at a user interface 22 associated with the host system 20 and sending configuration commands 24 to the printer 10. Configuration by the host system 20 may occur in real-time. In an example embodiment, the host system 20 may configure the printer 10 to return only the status information that the host system 20 is currently concerned with. Other status items will not be returned unless the configuration is changed by the host system 20 to include them. For example, when the host system 20 determines that it requires notification of a paper out condition at the printer, the host system 20 will configure the printer 10 to return that status information.

Non-volatile memory 12 may be provided for storing at least one of the time interval and the status information at the printer 10.

In an alternative example embodiment, at least one of the time interval or the status information may be provided from a removable memory device 30 insertable into the printer. The removable memory device 30 may comprise one of a compact flash card, a smart card, a smart media card, a USB flash drive, a memory stick, a plug in serial EEPROM, or the like.

The means for generating the printer status information (e.g., processor 16) may detect an activity level at the printer 10, and (1) decreases the periodic time interval when the activity level increases; or (2) increases the periodic time interval when the activity level decreases. This process may be referred to as TVSU (Time Varying Status Update).

The host system 20 may comprise one of a cash register, a point of sale terminal, a slot machine, a gaming terminal, a lottery ticket machine, a transportation ticket vending machine, an entertainment ticket vending machine, or the like.

The periodic status updating of the present invention overcomes the disadvantages of the prior art by, for example: (1) sending unsolicited information, which avoids unwanted delays between status request and status responses; and (2) always sending the printer's status state, which avoids the hidden condition where the printer has become non-responsive or non-functional due to some sort of failure. Moreover, the host system can be programmed to watch for the status update at the established time period. If a longer time elapses and no status update is received, the host system will know that something is wrong with the printer and can take appropriate action (e.g., entering a fault routine and/or taking the printer offline).

It should now be appreciated that the present invention provides advantageous methods and apparatus for providing status updates from a printer to a host system on a periodic basis without the need for a status request from the host system or a status change at the printer.

Although the invention has been described in connection with various illustrated embodiments, numerous modifications and adaptations may be made thereto without departing from the spirit and scope of the invention as set forth in the claims.

1. A method for providing periodic status updates from a printer to a host system, comprising:
automatically sending printer status information from the printer to the host system at periodic time intervals.

2. A method in accordance with claim 1, wherein:
the periodic time intervals each comprise a constant time interval of between 5 seconds and 10 milliseconds.

3. A method in accordance with claim 1, wherein:
the periodic time interval is configurable.

4. A method in accordance with claim 1, wherein:
the status information comprises at least one of paper status, ink status, paper low, paper out, paper jam, ticket in path, top of form, barcode complete, validation field complete, field printed, and percentage of printing completed.

5. A method in accordance with claim 1, further comprising:
configuring at least one of the time interval and the status information via the host system.

6. A method in accordance with claim 1, further comprising:
storing at least one of the time interval and the status information in non-volatile memory of the printer.

7. A method in accordance with claim 1, wherein:
at least one of the time interval and the status information is provided from a removable memory device insertable into the printer.

8. A method in accordance with claim 7, wherein:
the removable memory device comprises one of a compact flash card, a smart card, a smart media card, a USB flash drive, a memory stick, or a plug in serial EEPROM.

9. A method in accordance with claim 1, further comprising:
detecting an activity level at the printer;
decreasing the periodic time interval when the activity level increases; and
increasing the periodic time interval when the activity level decreases.

10. A method in accordance with claim 1, wherein:
the host system comprises one of a cash register, a point of sale terminal, a slot machine, a gaming terminal, a lottery ticket machine, a transportation ticket vending machine, or an entertainment ticket vending machine.

11. A printer capable of providing periodic status updates to a host system, comprising:
means for generating printer status information; and
means for automatically sending the printer status information to the host system at periodic time intervals.

12. A printer in accordance with claim 11, wherein:
the periodic time intervals each comprise a constant time interval of between 5 seconds and 10 milliseconds.

13. A printer in accordance with claim 11, wherein:
the periodic time interval is configurable.

14. A printer in accordance with claim 11, wherein:
the status information comprises at least one of paper status, ink status, paper low, paper out, paper jam, ticket in path, top of form, barcode complete, validation field complete, field printed, and percentage of printing completed.

15. A printer in accordance with claim 11, wherein:
at least one of the time interval and the status information is configured via the host system.

16. A printer in accordance with claim 11, further comprising:
non-volatile memory for storing at least one of the time interval and the status information at the printer.

17. A printer in accordance with claim 11, wherein:
at least one of the time interval or the status information is provided from a removable memory device insertable into the printer.

18. A printer in accordance with claim 17, wherein:
the removable memory device comprises one of a compact flash card, a smart card, a smart media card, a USB flash drive, a memory stick, or a plug in serial EEPROM.

19. A printer in accordance with claim 11, wherein:
the means for generating the printer status information detects an activity level at the printer, and (1) decreases the periodic time interval when the activity level increases; or (2) increases the periodic time interval when the activity level decreases.

20. A printer in accordance with claim 11, wherein:
the host system comprises one of a cash register, a point of sale terminal, a slot machine, a gaming terminal, a lottery ticket machine, a transportation ticket vending machine, or an entertainment ticket vending machine.
